(19) United States
(12) Patent Application Publication
(10) Pub. No.: US 2011/0197187 A1
(43) Pub. Date: Aug. 11, 2011

(54) VEHICLE SOFTWARE DOWNLOAD SYSTEM AND METHOD THEREOF

(76) Inventor: Seung Hyun ROH, Suwon-si (KR)

(21) Appl. No.: 13/022,154

(22) Filed: Feb. 7, 2011

(30) Foreign Application Priority Data
Feb. 8, 2010 (KR) 10-2010-0011412

(51) Int. Cl. G06F 9/44

(52) U.S. Cl. 717/173

(57) ABSTRACT

The present invention relates to a vehicle software download system and a method thereof, in which electronic control unit (ECU) software is downloaded and a corresponding ECU is updated if the version of ECU software stored in memory is lower than the version of ECU software broadcasted from an external apparatus, thereby promptly updating the ECU software installed in the vehicle.

To this end, there is provided a system for updating software of an ECU installed in a vehicle by communicating with an external apparatus having software of the vehicle stored therein, the system comprising: a receiving unit for receiving ECU software version information broadcasted from the external apparatus; a determination unit for comparing ECU software version information stored in a memory with the ECU software version information received through the receiving unit and determining whether or not an ECU software version stored in the memory is lower than a received software version; a download request unit for requesting download of software of a corresponding version from the external apparatus if the ECU software version stored in the memory is lower than the received software version; and a software providing unit for providing the corresponding ECU with the software downloaded from the external apparatus for software update.

### BACKGROUND OF THE INVENTION

1. Field of the Invention

The present invention relates to a vehicle software download system and a method thereof, and more specifically, to a vehicle software download system and a method thereof, which can simultaneously update vehicle software.

2. Description of the Related Art

If software including information on an electronic control unit (ECU) stored in a vehicle is desired to be updated, the vehicle is connected to a terminal having new software stored therein using a communication port such as a communication line, and then the new software is downloaded to the vehicle through the communication port.

At this point, since the terminal having the new software stored therein should be connected to each vehicle, a large amount of manpower and time is required to download the new software into the vehicles.

Particularly, when a large scale of recall is launched on vehicles, workers should repeat the operation of connecting a terminal to each vehicle and updating the vehicle with new software.

Further, if a driver feels that new software is needed, the driver should inconveniently visit a garage or a service center designated by a car company to update vehicle software with the new software.

Therefore, it is difficult to promptly update software of a vehicle, and excessive time and manpower are required. Accordingly, the driver should accept inconvenience of updating software of a vehicle or, in some cases, use the vehicle without updating the software.

### SUMMARY OF THE INVENTION

An object of the present invention is to provide a vehicle software download system and a method thereof, in which software of an electronic control unit (ECU) is downloaded and a corresponding ECU is updated if the version of ECU software stored in a memory is lower than the version of ECU software broadcasted from an external apparatus, thereby promptly updating the software of the ECU installed in the vehicle without visiting a garage or a service center.

According to an aspect of the present invention for achieving the objects, there is provided a system for updating software of an ECU installed in a vehicle by communicating with an external apparatus having software of the vehicle stored therein, the system comprising: a receiving unit for receiving ECU software version information broadcasted from the external apparatus; a determination unit for comparing ECU software version information stored in a memory with the ECU software version information received through the receiving unit and determining whether or not an ECU software version stored in the memory is lower than a received software version; a download request unit for requesting download of software of a corresponding version from the external apparatus if the ECU software version stored in the memory is lower than the received software version; and a software providing unit for providing the corresponding ECU with the software downloaded from the external apparatus for software update.

The ECU is preferably updated using the software provided by the software providing unit.

In addition, the system according to an embodiment of the present invention preferably further comprises an update completion transmission unit for transmitting information notifying completion of software update to the external apparatus if the software update is completed in the ECU.

According to another aspect of the present invention, there is provided a method for updating software of an ECU installed in a vehicle through a gateway having a function of communicating with an external apparatus having software of the vehicle stored therein, the method comprising the steps of: receiving, by the gateway, ECU software version information broadcasted from the external apparatus; comparing, by the gateway, ECU software version information stored in a memory with the received ECU software version information and determining whether or not an ECU software version stored in the memory is lower than a received software version; requesting, by the gateway, download of software of a corresponding version from the external apparatus if the ECU software version stored in the memory is lower than the received software version as a result of the determination step; and providing, by the gateway, the corresponding ECU with the software downloaded from the external apparatus for software update.

The ECU is preferably updated using the provided software.

The vehicle software download method according to another embodiment of the present invention further comprises the steps of receiving, by the gateway, a software update completion signal from the ECU, and transmitting, by the gateway, information notifying completion of software update to the external apparatus, after the step of providing the corresponding ECU.

### BRIEF DESCRIPTION OF THE DRAWINGS

FIG. 1 is a block diagram schematically showing a vehicle software download system according to an embodiment of the present invention.

FIG. 2 is a block diagram illustrating a gateway shown in FIG. 1.

FIG. 3 is a flowchart illustrating a software download method of a vehicle software download system according to another embodiment of the present invention.

FIG. 4 is a flowchart illustrating a vehicle software download method performed in a gateway.

### DESCRIPTION OF THE PREFERRED EMBODIMENT

Hereinafter, embodiments according to the present invention will be described in detail with reference to the accompanying drawings. The embodiments of the present invention are not to be construed as limiting. Throughout the drawings, like reference numerals are used to designate like elements.

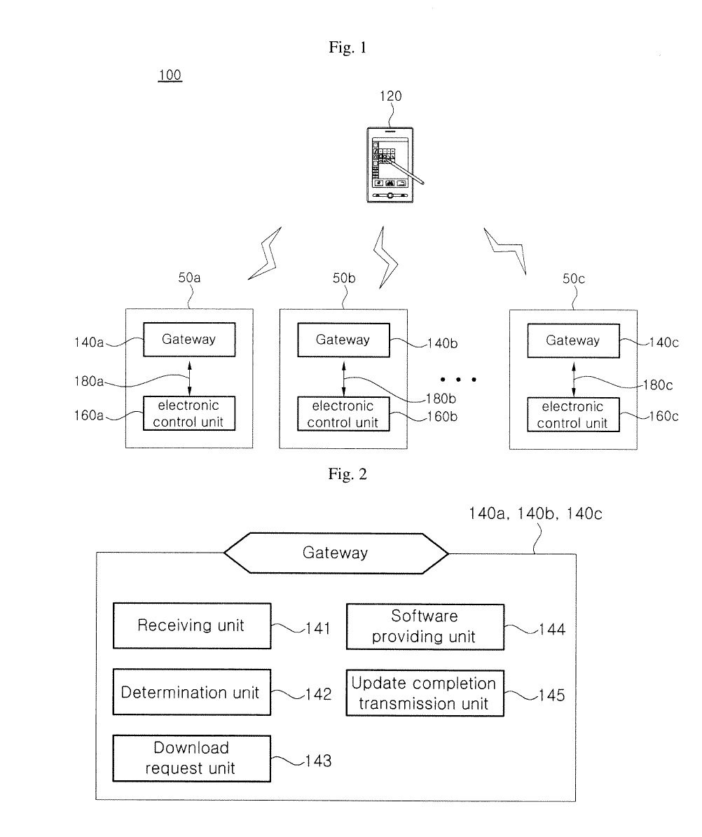

FIG. 1 is a block diagram schematically showing a vehicle software download system according to an embodiment of the present invention.

Referring to FIG. 1, the vehicle software download system 100 according to the embodiment of the present invention comprises an external apparatus 120, gateways 140a, 140b and 140c, and electronic control units (ECUs) 160a, 160b and 160c.

The external apparatus 120 can be a wireless communication device of a handheld terminal such as a cellular phone, a navigator and a portable multimedia player (PMP). The external apparatus 120 may store the latest software for updating software of vehicles 50a, 50b and 50c. The latest software can be downloaded from the external apparatus 120 through a garage, a service center, an Internet service provider or the like.

The gateways 140a, 140b and 140c are installed in the vehicles 50a, 50b and 50c, respectively. The gateways 140a, 140b and 140c may be connected to the external apparatus 120 in wireless and receive the latest software broadcasted from the external apparatus 120.

At this point, the vehicles 50a, 50b and 50c may be connected to the external apparatus 120 when they are positioned within a certain distance from the external apparatus. That is, since the external apparatus 120 is connected to the gateways 140a, 140b and 140c in wireless, there may be a communication range or distance allowing a wireless communication. Accordingly, the vehicles 50a, 50b and 50c and the external apparatus 120 are preferably located within a maximum range or distance that allows a wireless communication, and the maximum range allowing a wireless communication can be changed depending on conditions required in the present invention.

The gateways 140a, 140b and 140c can be connected to the ECUs 160a, 160b and 160c of the vehicles 50a, 50b and 50c in a wired communication. That is, the gateways 140a, 140b and 140c can be connected to the ECUs 160a, 160b and 160c using diagnostic connection ports 180a, 180b and 180c such as a communication line, an electric wire or the like.

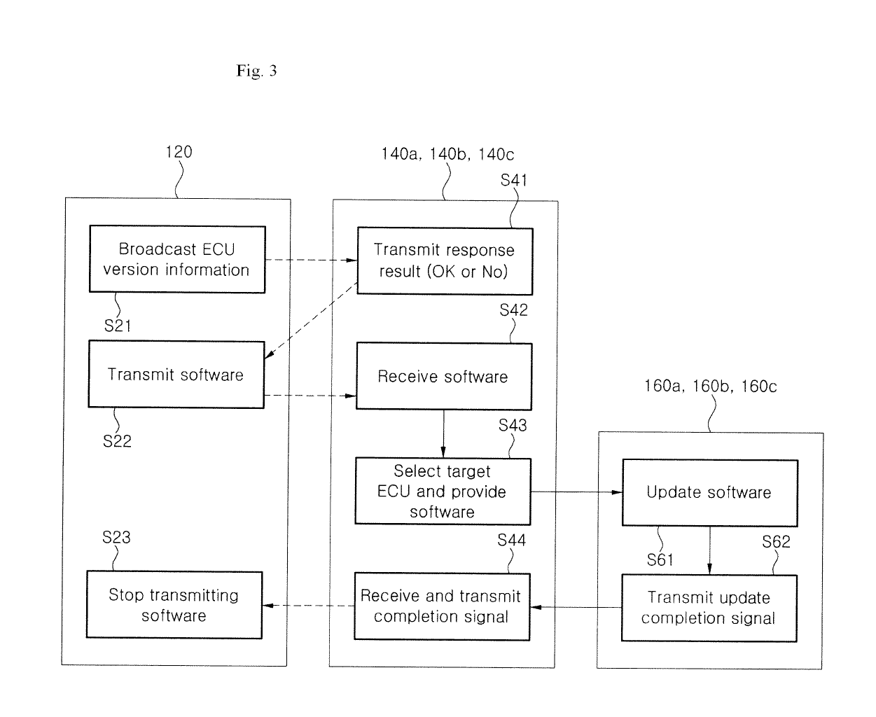

Referring to FIG. 2, the gateway 140a, 140b or 140c comprises a receiving unit 141, a determination unit 142, a download request unit 143, a software providing unit 144 and an update completion transmission unit 145.

The receiving unit 141 receives ECU software version information broadcasted from the external apparatus 120. The ECU software version information may include identification information of the ECU.

The determination unit 142 compares the ECU software version information received through the receiving unit 141 with ECU software version information stored in a memory (not shown) and determines whether or not the ECU software version stored in the memory is lower than the ECU software version received through the receiving unit 141. That is, the determination unit 142 can determine whether or not the ECU software version stored in the memory is the latest software version. The ECU may include a suspension ECU, a brake ECU, a steering ECU, and the like.

If the ECU software version stored in the memory is lower than the ECU software version received from the external apparatus 120 as a result of the determination of the determination unit 142, the download request unit 143 requests download of software from the external apparatus 120.

The software providing unit 144 receives software in response to the download request from the external apparatus 120 and provides a corresponding ECU with the received software. At this point, the software providing unit 144 may provide the corresponding ECU with the software received from the external apparatus 120 based on the ECU identification information included in the aforementioned version information.

If the update completion transmission unit 145 receives a software update completion signal from the ECU, it creates information on the completion of update of the corresponding ECU and transmits the created update completion information to the external apparatus 120.

It is described in this embodiment that software download is requested if the ECU software version stored in the memory is lower than the ECU software version received from the external apparatus 120. However, in another embodiment, the external apparatus 120 may broadcast software together with information on the ECU software version, and the gateways 140a, 140b and 140c may compare the software versions and immediately provide a corresponding ECU with the software for software update.

In this configuration, software stored in the plurality of vehicles 50a, 50b and 50c can be simultaneously updated. That is, the latest software stored in the external apparatus 120 can be transmitted to the gateways 140a, 140b and 140c of the respective vehicles 50a, 50b and 50c, and the latest software transmitted to the gateways 140a, 140b and 140c can be transferred to the respective ECUs 160a, 160b and 160c to be updated.

Hereinafter, the operation of the software download system 100 will be described with reference to drawings.

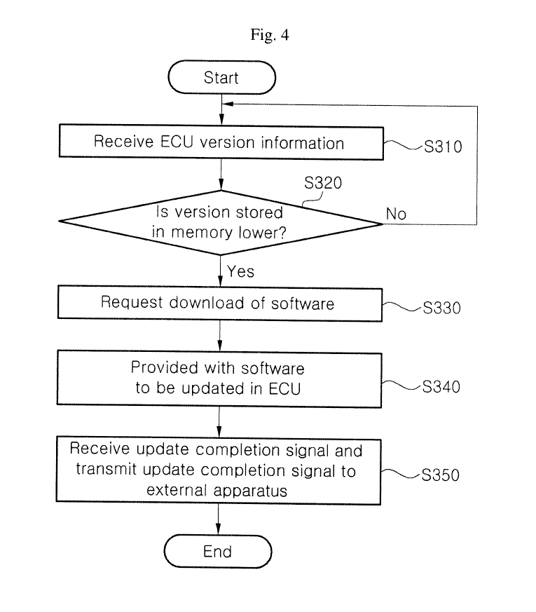

FIG. 3 is a flowchart illustrating a software download method of a vehicle software download system according to another embodiment of the present invention, and FIG. 4 is a flowchart illustrating a vehicle software download method performed in a gateway.

Referring to FIG. 3, the external apparatus 120 broadcasts information on the ECU software version in order to update the vehicles 50a, 50b and 50c with the latest software (S21).

The gateway 140a, 140b or 140c transmits a response result to the external apparatus 120 based on the broadcasted ECU software version information (S41). Here, the response result is a download-request (OK) if the ECU software version stored in the memory is lower than the broadcasted ECU software version, or the response result is a download-none-request (NO) if the ECU software version stored in the memory is higher than the broadcasted ECU software version.

The external apparatus 120 may display the response result of update in letters, colors or a combination of these. For example, if the gateway 140a, 140b or 140c completes authentication, letters or a color button corresponding to <OK> is displayed on the external apparatus 120, and whether or not to perform the update is determined.

Then, if download is requested, the external apparatus 120 transmits the latest ECU software (S22).

The gateway 140a, 140b or 140c that has transmitted a download-request as a response result receives the latest ECU software from the external apparatus 120 (S42). Although all the response results in this embodiment are a download-request, it is apparent that the software is not transmitted to the gateway of a vehicle if the response result is a download-none-request.

Next, the gateway 140a, 140b or 140c selects a target ECU to be updated with the received latest ECU software and provides the selected target ECU with the latest software (S43).

Since the vehicle is provided with a suspension ECU, a brake ECU, a steering ECU, and the like, the gateway can select the target ECU based on the ECU identification information included in the ECU software version information received in the aforementioned step S21.

Then, the ECU 160a, 160b or 160c is updated with the provided latest software (S61). If the update is completed, the ECU transmits an update completion signal to the gateway 140a, 140b or 140c (S62).

The gateway 140a, 140b or 140c receives the update completion signal and transmits the update completion signal to the external apparatus 120 (S43).

Accordingly, the external apparatus 120 stops transmitting the latest software (S23).

Hereinafter, a vehicle software download method performed in a gateway of the vehicle software download system will be described.

Referring to FIG. 4, the receiving unit 141 receives ECU software version information broadcasted from the external apparatus 120 (S310). At this point, a vehicle is positioned at a distance capable of communicating with the external apparatus 120.

The determination unit 142 compares the received ECU software version information with ECU software version information stored in a memory and determines whether or not the ECU software version stored in the memory is lower than the received ECU software version (S320).

If the ECU software version stored in the memory is higher than the received ECU software version as a result of the determination in step S320, the process goes to step S310 described above, and the ECU software version information broadcasted from the external apparatus 120 is received.

If the ECU software version stored in the memory is lower than the received ECU software version as a result of the determination in step S320, the download request unit 143 transmits a request of software download to the external apparatus 120 (S330).

Next, the software providing unit 144 provides a corresponding ECU with software downloaded from the external apparatus 120 in response to the request of software download (S340). That is, the software providing unit 144 selects an ECU to be updated with the downloaded software and provides the selected ECU with the software. The ECU to be updated with the downloaded software can be selected based on ECU identification information included in the aforementioned version information or based on the version information.

Next, if the update completion transmission unit 145 receives an update completion signal from a corresponding ECU, it transmits information indicating completion of update to the external apparatus 120.

In this manner, a gateway of a vehicle receives information on the ECU software version broadcasted from the external apparatus and determines whether or not to download software, so that ECU software can be conveniently updated without visiting a garage or a service center.

For example, if some pieces of software in vehicles are defective and a recall is announced, the vehicles 50a, 50b and 50c are collectively updated with the latest software using the external apparatus 120 and the gateways 140a, 140b and 140c, and thus time and manpower needed for update can be minimized.

According to an embodiment of the present invention, it is effective in that if the ECU software version stored in the memory is lower than the ECU software version broadcasted from the external apparatus, ECU software is downloaded, and a corresponding ECU can be updated. Accordingly, the ECU software can be promptly updated without visiting a garage or a service center in order to update software of a variety of ECUs installed in a vehicle, and thus time and manpower needed for update can be minimized.

Furthermore, according to an embodiment of the present invention, if the ECU software version stored in the memory is lower than the ECU software version broadcasted from the external apparatus, download of software from the external apparatus is requested, and thus it is effective in that memory space can be efficiently managed by downloading only the latest software.

The scope of the present invention is not limited to the embodiment described and illustrated above but is defined by the appended claims. It will be apparent that those skilled in the art can make various modifications and changes thereto within the scope of the invention defined by the claims. Therefore, the true scope of the present invention should be defined by the technical spirit of the appended claims.

What is claimed is:

1. A system for updating software of an electronic control unit (ECU) installed in a vehicle by communicating with an external apparatus having software of the vehicle stored therein, the system comprising:
a receiving unit for receiving ECU software version information broadcasted from the external apparatus;
a determination unit for comparing ECU software version information stored in a memory with the ECU software version information received through the receiving unit and determining whether or not an ECU software version stored in the memory is lower than a received software version;
a download request unit for requesting download of software of a corresponding version from the external apparatus if the ECU software version stored in the memory is lower than the received software version; and
a software providing unit for providing the corresponding ECU with the software downloaded from the external apparatus for software update.

2. The system as claimed in claim 1, wherein the ECU is updated using the software provided by the software providing unit.

3. The system as claimed in claim 2, further comprising an update completion transmission unit for transmitting information notifying completion of software update to the external apparatus if the software update is completed in the ECU.

4. A method for updating software of an ECU installed in a vehicle through a gateway having a function of communicating with an external apparatus having software of the vehicle stored therein, the method comprising the steps of:
receiving, by the gateway, ECU software version information broadcasted from the external apparatus;
comparing, by the gateway, ECU software version information stored in a memory with the received ECU software version information and determining whether or not an ECU software version stored in the memory is lower than a received software version;
requesting, by the gateway, download of software of a corresponding version from the external apparatus if the ECU software version stored in the memory is lower than the received software version as a result of the determination step; and
providing, by the gateway, the corresponding ECU with the software downloaded from the external apparatus for software update.

5. The method as claimed in claim 4, wherein the ECU is updated using the provided software.

6. The method as claimed in claim 4, further comprising the steps of receiving, by the gateway, a software update completion signal from the ECU, and transmitting, by the gateway, information notifying completion of software update to the external apparatus, after the step of providing the corresponding ECU.
